(19) United States
(12) Patent Application Publication
(10) Pub. No.: US 2025/0306918 A1
(43) Pub. Date: Oct. 2, 2025

(54) RECURSIVE ARTIFICIAL INTELLIGENCE CODE FIX CIRCUIT

(71) Applicant: PayPal, Inc., San Jose, CA (US)

(72) Inventors: Jack Zante Hays, San Francisco, CA (US); Gopalsamy Siddharth Ramgopal, San Jose, CA (US); Harrison Hongchul Kim, Cary, NC (US)

(21) Appl. No.: 18/616,387

(22) Filed: Mar. 26, 2024

(51) Int. Cl. G06F 8/72; G06F 8/41

(52) U.S. Cl. CPC G06F 8/72; G06F 8/41

(57) ABSTRACT

Systems, methods, and computer program products for correcting code issues, such as code smells, using artificial intelligence, are provided. A code issue in one of multiple source code files is determined. An artificial intelligence model, such as a large language model, receives the code issue and the multiple source code files. The AI model recursively modifies at least one source code file from the multiple source code files until the code issue and an error or errors introduced by modifying the at least one source code file are resolved, and the source code files are issue free.

### TECHNICAL FIELD

The disclosure generally relates to correcting source code using, and more specifically to recursively rectifying source code issues using artificial intelligence.

### BACKGROUND

When a source code review software analyzes source code, the source code review software may detect source code issues, such as source code smells and/or source code errors. Correcting the source code smells or errors in one file may introduce errors in other files during a subsequent source code review.

### BRIEF DESCRIPTION OF THE DRAWINGS

FIG. 1 is an exemplary system where a recursive circuit can be implemented.

FIG. 2A-B are block diagrams of a recursive circuit, according to some embodiments.

FIGS. 3-4 are flowcharts of methods for recursively correcting code issues using artificial intelligence, according to an embodiment.

FIG. 5 is a block diagram of a computer system suitable for implementing one or more components or operations in FIGS. 1-4 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to rectifying code issues, such as code smells, code errors, and the like in the source code files. Code smells may be characteristics of code that may be indicative of a bad program design or may negatively affect quality of the program. Code smells are typically not technically incorrect. As such, code smells may not always be identified by a compiler, interpreter, or a static code analyzer. However, code smells may increase risk of bugs or failures within the program during execution, or may adversely affect how the program functions, such as causing a program to crash unexpectedly by accessing unallocated memory space or overwriting memory allocated to another object or variable. Code errors may include improper function calls, private/public variable and/or function mismatch, improper dependencies, improperly linked files, syntax errors, undeclared variables, returning a variable having a wrong type, including duplicate variables having different types, missing statements, etc.

The code issues may be identified using a compiler, an interpreter, a static code analyzer, or a code smell module. Once detected, a recursive circuit that includes an AI system implementing one or more machine learning techniques, such as a large language model, decision trees, random forest trees, vector support trees, and the like, may access, e.g., receive from a memory storage, via user interface, a network, etc., the source code (or files that include the source code) and automatically rectify the code issue. In some instances, rectifying the code issue may cause other code issues (other code smells, errors, etc.,) in the same or different files. For example, after the AI system modifies a source code in one file, a compiler, static analyzer, interpreter, or a code smell module may identify further source code issue(s) that result from the source code modification. The source code issue(s) may occur in the same or different source code files due to improper function calls, private/public variable and/or function mismatch, improper dependencies, improperly linked files, syntax errors, undefined variables, returning a variable having a wrong type, including duplicate variables having different types, missing statements, etc. The recursive circuit may use AI system to recursively modify the source code in the same or different source code files and recompile, reinterpret, or reanalyze the source code, until the source code is issue free.

In some instances, the AI system may include one or more large language models or other machine learning techniques. An example large language model (LLM) may be a generative pre-trained transformer (GPT) model, such as GPT-4 or its variants, a Bidirectional Encoder Representations from Transformers (BERT) model, a Robustly Optimized BERT Pretraining Approach (ROBERTa) model, a permutation language model, and the like. The large language mode may be trained on data in a natural language, including text, words, sentences, documents and the like. In some instances, the large language model may be trained using a training dataset that includes source code in various programming languages, compiler errors, code smells, and the like. In some instances, an LLMs may also receive images, such as images that include source code.

In some embodiments, LLMs may also be a Retrieval Augmented Generation (RAG) based LLM. A RAG based LLM may receive as prompt pre-existing text, e.g., pre-existing source code, in addition to the source code that may include a code issue and may use the pre-existing text in addition to the trained data to correct the code issue in the source code.

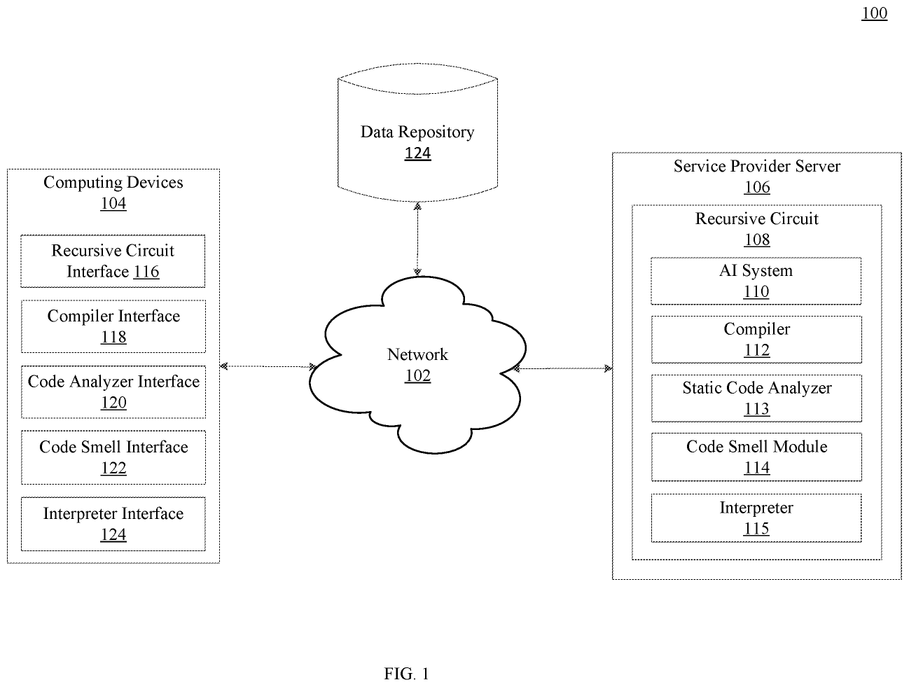

FIG. 1 is an exemplary system 100 where embodiments can be implemented. System 100 may be a computing environment or a computing system. System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104 and service provider server(s) 106. Computing devices 104 may be portable and non-portable electronic devices under the control of a user and configured to transmit, receive, and manipulate data from service provider server(s) 106 over network 102. Example computing devices 104 include desktop computers, laptop computers, tablets, smartphones, wearable computing devices, eyeglasses that incorporate computing devices, implantable computing devices, etc.

Server(s) 106 may be electronic devices configured for large scale data processing and service, and may include a physical computer, a data center, a server program that facilitates processing, and the like. Server 106 may include a recursive circuit 108. Recursive circuit 108 may be implemented in software, hardware, or a combination of software and hardware. Recursive circuit 108 may include an AI system 110. AI system 110 may be a generative AI system and may automatically modify source code to fix source code issues, such as compilation errors and code smells. AI system 110 may include one or more LLMs. The LLMs may be artificial intelligence networks, including deep neural networks, recurrent neural networks, convolutional neural networks, etc., that are trained to understand language from text, images, or audio inputs, and in various languages. The LLMs may include multiple layers, and multiple nodes within each layer that interconnect preceding and subsequent layers. As the data flows through the layers of the LLMs, the nodes may be activated using an activation function. The activation function may determine whether the data from the node is propagated to the subsequent layer. There may be thousands of layers, and billions of nodes in LLMs. During training, data from a training dataset flows through the model over thousands of iterations until the training dataset generates an expected output. Between each iteration, the weights associated with the nodes may be changed or modified until LLMs generate an answer within a predefined error threshold.

As discussed above, some example LLMs may include GPT models (e.g., GPT-4 and its variants), BERT models, ROBERTa models, permutation language models, and the like. In some embodiments, LLMs may also be a Retrieval Augmented Generation (RAG) based LLMs that receive pre-existing text, e.g., pre-existing source code as part of the prompt that aids the LLM in determining an answer to the prompt, e.g., a solution that would correct a source code that includes a code issue.

In another embodiment, LLMs may be differential evolution models. The differential evolution models may first identify an order or a sequence of tasks, prior to performing the tasks. For example, a differential receive multiple code issues, and may first determine an order for resolving multiple code issues. After determining the order for resolving the code issues, LLMs may generate a solution to each code issue in the determined order.

In some instances, after LLMs are trained, LLMs may be finetuned for a specific purpose or task. The task may be correcting code issues. The finetuning may involve training LLMs on a specialized training dataset, such as a training dataset that includes source code in various languages, source code issues, including source code errors, source code smells, and the like.

Once LLMs are trained, LLMs may be placed in a real-world to receive requests for information. The requests for information may be modifying an error in a source code file(s), propose source code modifications in one or more files, and the like. In some instances, the requests for information may be in a natural language in an alphanumeric form, audio form, video form, image, and the like. Based on the requests for information, one or more LLMs may generate a response, which may include a source code with a change that removes the source code issue(s), source code modification strategy, and the like. For RAG based LLMs, the requests may also include pre-existing text or other input (e.g., pre-existing source code, a code snippet, or another text prompt) that may aid the LLMs in generating the response, e.g., a source code that rectifies the code issue. For differential evolution models, the request may include code issues, with a first response identifying the order for resolving the code issues, and subsequent responses with the source code that rectifies the code issues.

In some embodiments, recursive circuit 108 may include or be communicatively connected to a compiler 112, a static code analyzer 113 or a code smell module 114. Although shown on a single server 106, recursive circuit 108, including AI system 110, compiler 112 and static code analyzer 113, and code smell module 114 may also execute on multiple servers 106 and/or on computing devices 104.

Computing device(s) 104 may include a recursive circuit interface 116, compiler interface 118, code analyzer interface 120, and code smell interface 122. Recursive circuit interface 116 may be an interface that receives text input, audio input, or a natural language input from a user operating computing device 104. For example, a user may establish a session with recursive circuit 108 over recursive circuit interface 116 and enter a request, files, e.g., one or more files that include source code in one or more programming languages, compiler errors, analyzer errors, code smells, etc. Recursive circuit interface 116 may communicate with recursive circuit 108 and provide an output generated by the AI system 110, including error free source code that initially included code issues.

Compiler 112 may be a program that translates the entire source code into machine readable code that may be executed as a program or an application. For simplicity, compiler 112 may translate the source code written in a variety of languages, including C, C++, Cobol, PL/1, and the like. In some instances, compiler 112 may access and/or receive the source code via compiler interface 118. The source code may be included in one or more source code files. Compiler 112 may complete compiling the source code either upon generating machine readable code or generating a list of compilation errors and/or warnings that aid with debugging the source code. The errors may be related to syntax errors, type mismatch errors, linking errors, and the like discussed above.

Compiler interface 118 may receive commands for compiling source code, paths to locations in system 100 to source code files that store the source code, libraries, etc., and pass the commands, paths, etc., to compiler 112. Compiler interface 118 may also display source code issues, such as source code errors, warnings, etc., that compiler 112 identified by compiling the source code. Compiler interface 118 may receive the commands as user input or as input from another application or system, such as AI system 110 or recursive circuit 108.

Static code analyzer 113 may be a program that analyzes source code without compiling the source code. The source code may be written in a variety of languages, including Python, C, C++, Java, JavaScript, HTML, CSS, Apex, Cobol, PL/1, Visual Basic, and the like, to identify poor coding practices, security flaws, undefined variables and/or pointers, etc. Static code analyzer 113 may generate a list that includes one or more errors or warning in the source code. The errors may be related to syntax errors type mismatch errors, linking errors, and the like. In some instances, static code analyzer 113 may access and/or receive the source code via code analyzer interface 120. The source come may be included in one or more files.

Code analyzer interface 120 may receive commands for analyzing source code, paths to locations in system 100 to source code files that store the source code, and pass the commands, paths, etc., to code analyzer interface 120. Code analyzer interface 120 may also display source code issues, such as source code errors, warnings, etc., that static code analyzer 113 identified by analyzing the source code. Code analyzer interface 120 may receive the commands as user input or as input from another application or system, such as AI system 110 or recursive circuit 108.

Interpreter 115 may be a program that interprets source code line by line into a machine readable language and executes each interpreted line of code. For simplicity, interpreter 115 may interpret source code written in a variety of languages, including Python, Java, JavaScript, HTML, CSS, Apex, Visual Basic, and the like. In some instances, interpreter 115 may access and/or receive the source code via interpreter interface 124. The source code may be included in one or more source code files. Interpreter 115 may complete interpreting the source code either upon completing execution of the source code or upon generating one or more errors and/or warnings that aid with debugging the source code. The errors may be related to syntax errors, type mismatch errors, linking errors, and the like discussed above.

Interpreter interface 124 may receive commands for compiling source code, paths to locations in system 100 to source code files that store the source code, libraries, etc., and pass the commands, paths, etc., to interpreter 115. Interpreter interface 124 may also display source code issues, such as source code errors, warnings, etc., that interpreter 115 identified by interpreting the source code. Interpreter interface 124 may receive the commands as user input or as input from another application or system, such as AI system 110 or recursive circuit 108.

In some instances, the source code may be compiled and interpreted using a just-in-time (JIT) compiler (not shown) that interprets some sections of the code and compiles other sections of the code. For example, the JIT compiler may compile portions of source code that are frequently used during execution while interpreting other portions of the source code. In this scenario, the source code issues may be identified during the compilation or interpretation process.

Code smell module 114 may be a program that that analyzes source code and identifies code smells in the source code. As discussed above, a code smell is a characteristic in the source code that may be indicative of a problem but that may not be caught by compiler 112, interpreter 115, or static code analyzer 113 because a code smell is not a syntax error. Rather, a code smell may be indicative of a bad program design that may cause issues or adverse effects in the program execution and function. An example code smell may be a direct access to a variable marked as private from another function or method, rather than using a set and get functions that may set and retrieve the private variable. An example code smell may be a duplicate code or function name. Another example code smell may be a comment over a predefined number of characters in length, or a comment that is not designated as a comment on both sides of text. Another example code smell may be a parameter list for a function that is over a predefined number of parameters. Another example code smell may be an improper or a non-standard name for a class, function or a variable, such as one or two letter function or variable names, non-descriptive functions or variables, etc. Another example code smell may be a class that has too many fields, e.g., a number of fields above a predefined threshold or a class that performs too many functions, e.g., above a predefined number of functions and does not delegate the work to other classes. Another example code smell is a lazy class that does not contribute or significantly contribute to a functionality of a program.

An example code smell may be found in the following line of code in file A:
static final string REPUBLISH_TO=“_republish_to”;
In this example, the code smell may indicate that the above line should start with “private static final” and not “static final.” This is because the string REPUBLISH_TO in the source code line above may be accessed directly without the get method. Accessing private variables without a get method is a sub-optimal coding practice and is indicative of a bad coding design because it lets other objects have direct access to an object's private data and makes the object susceptible to infiltration attacks.

Code smell module 114 may receive the source code in one or more files, and generate a list that includes one or more code smells. The source code may be written in a variety of languages, including Python, C, C++, Java, JavaScript, HTML, CSS, Apex, Cobol, PL/1, Visual Basic, and the like. Code smell module 114 may receive or access the source code in one or more files via code smell interface 122.

Code smell interface 122 may receive commands for identifying code smells in source code, paths to locations in system 100 that store the source code files with the source code, etc., and may pass the commands, paths, etc., to code smell module 114. Code smell interface 122 may also display code smells that code smell module 114 identified by analyzing the source code.

As discussed above, recursive circuit 108 may receive code issues, including code smells, and the source code in the one or more source code files, and use AI system 110 to automatically correct code issues in the source code. Additionally, recursive circuit 108 may also use AI system 110, compiler 112, interpreter 115, and/or static code analyzer 113 to recursively correct additional code errors that may have resulted from modifying the source code to correct the code issues. For example, with reference to a code smell above, AI system 110 may correct the code smell by modifying the static final String REPUBLISH_TO to be “private”, as follows:
private static final String REPUBLISH_TO=“_republish_to”;

However, this correction in file A may cause an error in file B that attempts to access the variable REPUBLISH_TO as follows:

```
public void test( ) {
....
  when(config.getString(s: “a” +
  AMQMessageHandler.REPUBLISH_TO)).thenReturn(putTO);
....
}
```

This is because, after the correction in file A, the test ( ) function in file B is trying to access a static private variable REPUBLISH_TO, which is not accessible by functions outside of the AMQMessageHandler object. Instead, to access, e.g., read a static private variable, a “get” method should be created and used. In this case, AI system 110 may further modify file A to include the “get” method that may read the private static variable REPUBLISH_TO.

Although, for simplicity, the embodiments discussed below pertain to correcting a code smell in two files, file A and file B, the embodiments are also applicable to other source code issues, including source code errors that may be raised by compiler 112, interpreter 115, and/or static code analyzer 113, in addition to code smell module 114, and that may also span multiple source code files.

System 100 may also include a data repository 126. Data repository 126 may be a database or another large memory storage that may store one or more source code files, employ version control of the source code files, and the like. The source code files may be accessed from data repository 126, downloaded onto computing device 104 and/or server 106, modified on either computing device 104 or server 106, and then uploaded back to data repository 126.

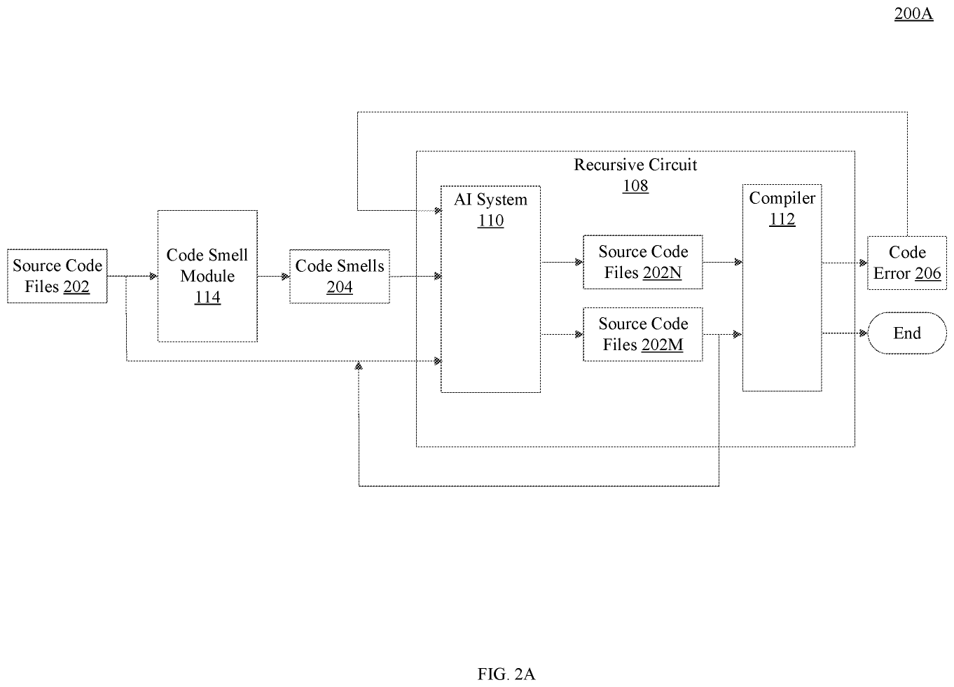

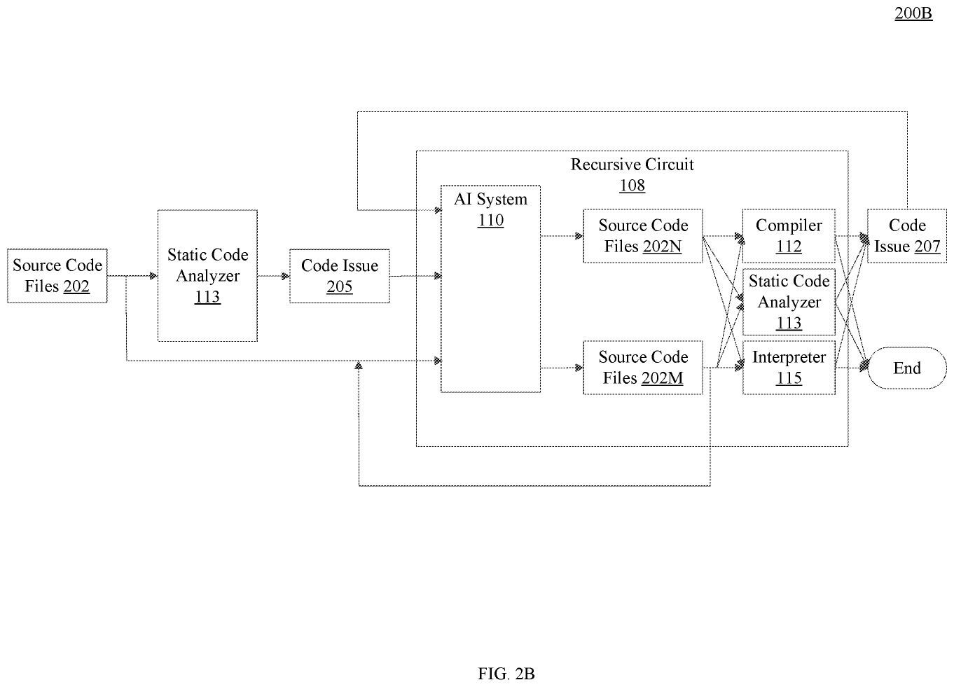

FIG. 2A is a block diagram 200A of a recursive circuit 108, according to some embodiments. As shown in FIG. 2A, recursive circuit 108 may receive one or more source code files 202 and a code smell 204. The code smell(s) 204 may be generated using code smell module 114, as discussed above. Although FIG. 2A illustrates recursive circuit 108 rectifying code smell 204, the embodiments are also applicable to other types of code issues.

Recursive circuit 108 may recursively correct the code smell 204 in one of source code file 202 that includes the code smell 204, and also in other source code files 202 that may have been impacted by correcting the code smell 204. For example, recursive circuit 108 may make changes to one of source code files 202, such as source code file 202M. Typically, the source code file that is modified includes the code smell 204. If the changes to the source code file 204M caused further code error(s) in other source code files 202, recursive circuit 108 may further modify the source code file 202M or other source code files 202 to correct the new code error(s). Additionally, recursive circuit 108 may generate multiple strategies and select a strategy for correcting the code smell 204 or subsequent code errors. Example strategies may be to modify a source code file in source code files 202 that was modified during a previous iteration, modify a source code file that caused a code error, modify multiple source code files to correct the code error, etc. Recursive circuit 108 may continue to recursively modify source code files 202 and recompile the source code in the source code files 202 using compiler 112 (or reinterpret the source code using interpreter 115 or reanalyze the source code using static code analyzer 113 (not shown)) to generate strategies for modifying the source code files 202, etc., until the source code in source code files 202 either compiles successfully or fails. Recursive circuit 108 may determine that the recursive process failed after a predefined number of iterations or after it has run out of strategies for modifying the source code.

Although recursive circuit 108 may receive multiple code smells, for illustrative purposes only, FIG. 2A illustrates recursive circuit 108 modifying source code in one or more source code files 202 to correct one code smell 204.

Recursive circuit 108 may use AI system 110, which may include an LLM (or another machine learning model), to receive and parse the one or more source code files 202 and code smell 204. AI system 110 may modify one or more source code files 202. Source code files 202N are a subset of source code files 202 that were not modified by AI system 110, and source code file(s) 202M are a subset of source code files 202 that were modified by AI system 110. In some instances, the subset of source code files 202M may include a source code file with the code smell 204.

Compiler 112 or static code analyzer 113 (not shown) or interpreter 115 (not shown) may receive source code files 202N and modified source code files 202M. Compiler 112 may compile source code files 202N and modified source code files 202M and generate no errors, at which point there are no further changes to source code files 202N and 202M. Alternatively, compiler 112 may generate code errors 206. Code errors 206 are then fed back into recursive circuit 108 along with modified source code files 202M, source code files 202N, and/or source code files 202 for another iteration. The AI system 110 may then further modify one or more of source code files 202M and/or 202N. The process then repeats until the source code in source code files 202 compiles without code errors 206.

In some instances, after AI system 110 modifies one or more source code file 202M during a first iteration, compiler 112 may compile source code files 202M and 202N without errors. In this case, the source code files 202 are corrected during a first iteration and without entering subsequent iterations that further modify source code files 202.

FIG. 2B is a block diagram 200B of a recursive circuit 108, according to some embodiments. As shown in FIG. 2B, recursive circuit 108 may receive one or more source code files 202 and a code issue(s) 205. The code issue(s) 205 may be generated using static code analyzer 113, as discussed above. Although not shown, code issue(s) 205 may also be generated using compiler 112 or interpreter 115. Further, the embodiments are also applicable to correcting code smell(s), such as code smell 204 discussed in FIG. 2A.

Recursive circuit 108 may recursively correct the code issue 205 in one of source code file 202 that includes the code issue 205, and also in other source code files 202 that may have been impacted by correcting the code issue 205. For example, recursive circuit 108 may make changes to one of source code files 202, such as source code file 202M. Typically, the source code file that is modified includes the code issue 205. If the changes to the source code file 204M caused further code issues in other source code files 202, recursive circuit 108 may further modify the source code file 202M or other source code files 202 to correct the new code issue. Additionally, recursive circuit 108 may generate multiple strategies and select a strategy for correcting the code smell 204 or subsequent code issues. Example strategies may be to modify a source code file in source code files 202 that was modified during a previous iteration, modify a source code file that caused a code issue, modify multiple source code files to correct the code issue, etc. Recursive circuit 108 may continue to recursively modify source code files 202 and recompile, reinterpret and/or reanalyze the source code in the source code files 202 using compiler 112, interpreter 115 and/or static code analyzer 113 depending on the programming language and/or instructions received from interface 116, generate strategies for modifying the source code files 202, etc., until the source code in source code files 202 either compiles successfully or fails. Recursive circuit 108 may determine that the recursive process failed after a predefined number of iterations or after it has run out of strategies for modifying the source code.

Although recursive circuit 108 may receive multiple code issues, for illustrative purposes only, FIG. 2B illustrates recursive circuit 108 modifying source code in one or more source code files 202 to correct one code issue 205.

Recursive circuit 108 may use AI system 110, which may include an LLM (or another machine learning model), to receive and parse the one or more source code files 202 and code issue 205. AI system 110 may modify one or more source code files 202. Source code files 202N are a subset of source code files 202 that were not modified by AI system 110, and source code file(s) 202M are a subset of source code files 202 that were modified by AI system 110. In some instances, the subset of source code files 202M may include a source code file with the code smell 204.

Compiler 112, static code analyzer 113, or interpreter 115 (depending on the source code implementation and/or instructions received via, e.g., interface 116) may receive source code files 202N and modified source code files 202M. Compiler 112 may compile source code files 202N and modified source code files 202M and generate no errors, at which point there are no further changes to source code files 202N and 202M. Alternatively, compiler 112 may generate code issues 207. Code issues 207 are then fed back into recursive circuit 108 along with modified source code files 202M, source code files 202N, and/or source code files 202 for another iteration. Interpreter 115 may interpret source code files 202N and modified source code files 202M and generate no errors, at which point there are no further changes to source code files 202N and 202M. Alternatively, interpreter 115 may generate code issues 207. Code issues 207 are then fed back into recursive circuit 108 along with modified source code files 202M, source code files 202N, and/or source code files 202 for another iteration. Static code analyzer 113 may analyze source code files 202N and modified source code files 202M and generate no errors, at which point there are no further changes to source code files 202N and 202M. Alternatively, static code analyzer 113 may generate code issues 207. Code issues 207 are then fed back into recursive circuit 108 along with modified source code files 202M, source code files 202N, and/or source code files 202 for another iteration.

The AI system 110 may then further modify one or more of source code files 202M and/or 202N. The process then repeats until the source code in source code files 202 is compiles without code issues 207.

In some instances, after AI system 110 modifies one or more source code file 202M during a first iteration, compiler 112 may compile source code files 202M and 202N without errors. In this case, the source code files 202 are corrected during a first iteration and without entering subsequent iterations that further modify source code files 202.

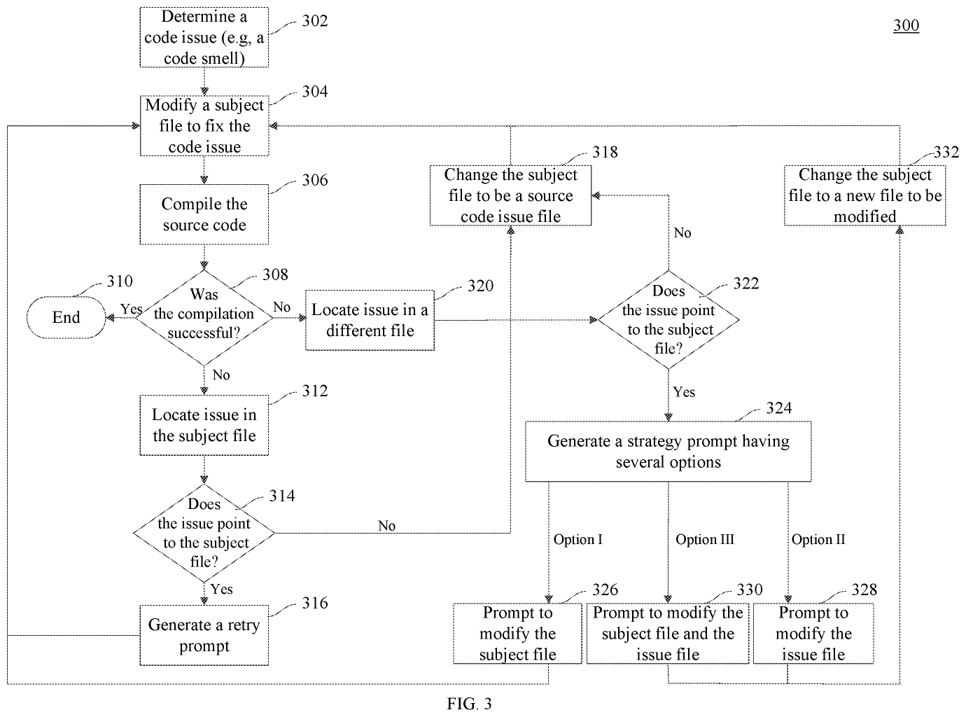

FIG. 3 is a flowchart of a method 300 that recursive circuit 108 may use to correct code smells, according to some embodiments. Notably, method 300 is exemplary and other methods may also be used. Method 300 may be performed using hardware and/or software components described in FIGS. 1-2. Note that one or more of the operations may be deleted, combined, or performed in a different order as appropriate.

At operation 302, a code issue is determined. For example, code smell module 114 may receive source code files 202 and identify a code issue, such as code smell 204. Alternatively, compiler 112, interpreter 115, and/or static code analyzer 113 may identify other code issues 205.

At operation 304, a subject file is modified. For example, recursive circuit 108 may receive source code files 202 and the code issue. Based on the code issue, AI system 110 may modify source code file 202M that includes the identified code issue to eliminate the code issue. For purposes of method 300, during the first iteration, the source code file 202M that is modified may be referred to as a subject file.

At operation 306, source code files are compiled. For example, compiler interface 118 may receive source code files 202, including source code file 202M and non-modified source code files 202N, and compile the source code files 202.

At operation 308, a determination is made as to whether the source code in source code files 202 has compiled successfully. If compiler 112 compiles the source code files 202 successfully, method 300 proceeds to operation 310 where method 300 ends. Alternatively, if the compilation fails, e.g., compiler 112 does not compile source code files 202 successfully, but generates code issues, method 300 proceeds to operations 312 or 320. In an alternative implementation, if interpreter 115 interprets the source code files 202 successfully and/or static code analyzer 113 analyzes the source code files 202 successfully, the 300 also proceeds to operation 310 and ends. Alternatively, if the interpretation with the interpreter 115 or static code analyzes with static code analyzer 113 fails, method 300 also proceeds to operations 312 or 320. In particular, method 300 proceeds to operation 312 if compiler 112 locates the code issue in the same file as the subject file, e.g., source code file 202M. At operation 312, the code issue and the subject file may also be logged. Alternatively, method 300 proceeds to operation 320 if the code issue is located in a different source code file (e.g., one of source code files 202N) from the subject file (e.g., source code file 202M). At operation 320, the code issue and the code file that includes the code issue may also be logged.

Once method 300 determines that the code issue is located in the subject file, e.g., source code file 202M, at operation 312, method 300 proceeds to operation 314. At operation 314, a determination is made as to whether the code issue in source code file 202M points to the subject file (e.g., source code file 202M) or to a different file (one of source code files 202N). If the code issue points to the subject file, method 300 proceeds to operation 316. If the code issue points to a different file, method 300 proceeds to operation 318.

At operation 316, a retry prompt is generated. For example, the AI system 110 may automatically generate a prompt that is fed back into to the AI system 110. An example prompt may be “This modification failed as it resulted in the following errors, can you retry?” The modification may be the modification in operation 304 and the code issue(s) may be code issue(s) generated in operation 306 and logged in operation 312. After operation 316, method 300 proceeds to operation 304, where the source code file 202M may be modified with changes to correct the compilation issue according to the prompt generated in operation 316. At operation 304, recursive circuit 108 performs another iteration of method 300. At this point, the subject file is source code file 202M.

As discussed above, if in operation 314 the code issue points to a different file, method 300 proceeds to operation 318. At operation 318, a subject file is changed. For example, recursive circuit 108 may change the subject file from source code file 202M to the source code file that compiler 112, interpreter 115, or static code analyzer 113 has identified as the source of the code issue. In some instances, the source code file identified as the source of the code issue may be a previous subject file during a preceding iteration or one of source code files 202N. After operation 318, method 300 proceeds to operation 304, where AI system 110 modifies the subject file designated in operation 318, to correct the compilation, interpretation, or static code analysis issue. At operation 304, recursive circuit 108 performs another iteration of method 300 where AI system 110 may modify the subject file determined in operation 318.

As discussed above, if the compilation, interpretation, or static code analysis was not successful at operation 308, method 300 proceeds to operation 320 where recursive circuit 108 determines that the compilation failed because the code issue is in one of source code files 202N that has not been designated as the subject file. After operation 320, method 300 proceeds to operation 322. At operation 322, a determination is made as to whether the code issue points to the subject file (e.g., source code file 202M) or to another file (e.g., one of source code files 202N or a file that was a subject file during a previous iteration). If the code issue points to a different file, method 300 proceeds to operation 318 discussed above, where the other file is changed to be the subject file. After operation 318, method 300 proceeds to a next recursive iteration at operation 304. If the code issue points to the subject file, method 300 proceeds to operation 324.

At operation 324, a strategy prompt is generated. For example, the AI system 110 may automatically generate a strategy prompt. The prompt may include a scenario summarizing the subject file, e.g., source code file 202M that was modified, a resulting code issue, and proposed strategies for further file modifications. An example prompt may be as follows:
“This file: {before Code} was modified to this: {after code}, and it resulted in the: {error file code+error info} which file should be modified to fix this? Option I: this file that was modified, Option II: the file that threw the error, and Option III: modify both files and why/what should be changed about it/them?”

AI system 110 may also display the prompt using recursive circuit interface 116. Notably, although three options are illustrated in operation 324, depending on the code issue, additional options may also be generated by the AI system 110. Once, at operation 324, AI system 110 generates various options, AI system 110 may also select one of the options using one of operations 326, 328, and 330.

At operation 326, an option to modify the subject file is selected. For example, AI system 110 may select to further modify subject file, e.g., source code file 202M. After operation 326, method 300 proceeds to operation 304, at which point recursive circuit 108 performs another iteration that modifies the source code file 202M according to option I.

Alternatively, at operation 328, an option to modify and an issue file is selected. For example, AI system 110 may select to modify a source code file in source code files 202N where an issue was located. For example, with reference to the code smell discussed in FIG. 1, AI system 110 may generated the following option:

```
“function_call”: {
    “name”: “suggest_resolution”,
    “arguments”: “{\n \“resolutionDescriptionForExternalFileB\”:
\“In the test file ‘AMQMessageHandlerTest.java’, remove the usages of
the private fields ‘REPUBLISH_TO’ and ‘publishers’ of the class
‘AMQMessageHandler’. Instead, update the test cases to test the public
contract of the ‘AMQMessageHandler’ class. This can include behavior
verification or state verification without depending directly on the internal
state of the object. For example, instead of checking the value of the
‘publishers’ field, check if a message was sent to the correct
‘MessageChannel’.\”,\n \“overallStrategy\”: \“The issue needs to be fixed
in the test file that threw the compilation error, without modifying the first
file that was originally modified. This is because the first file was
correctly modified to fix the original code smell. However, the test file
was directly accessing some private fields of the class
‘AMQMessageHandler’, which is not a good practice. The purpose of a
unit test is to test the observable behavior of an object, not its internal
state.\”,\n \“choice\”: \“B\”\n}”
  }
```

The strategy prompt, including the impacted source code files, or snippets from the source code files, may be displayed using recursive circuit interface 116.

Alternatively, at operation 330, an option to modify both the subject file and an issue file is selected. For example, AI system 110 may select to further modify subject file, e.g., source code file 202M and a source code file in source code files 202N where an issue was located.

After operations 328 and 330, method 300 proceeds to operation 332. At operation 332, the recursive circuit 108 may change the subject file to a new file to be modified, e.g., one of source code files 202N where the issue was located. After operation 332, method 300 proceeds to operation 304, at which point recursive circuit 108 performs another iteration.

Notably, some or all operations 302-332 may repeat recursively until compiler 112 (or interpreter 115, or static code analyzer 113) does not generate compilation issues due to modifying source code files 202. Once there are no further errors, the recursive circuit 108 completes making changes to source code files 202 at operation 310.

Although the embodiment in method 300 utilizes compiler 112, one or more of operations 302-332 in method 300 may also be implemented using static code analyzer 113.

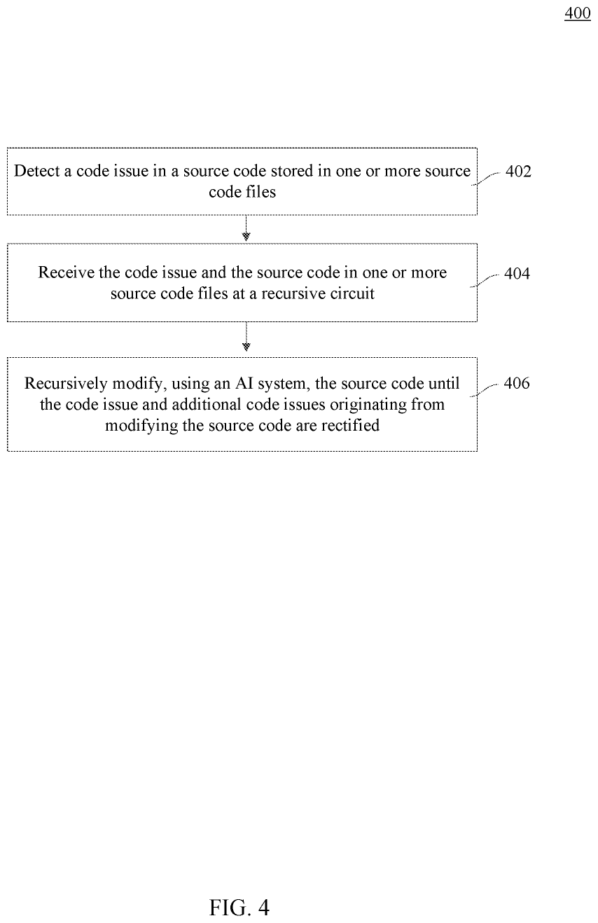

FIG. 4 is a flowchart of a method 400 that recursive circuit 108 may use to correct code issues according to some embodiments. Code issues may be code smells identified by code smell module 114 or code errors identified by compiler 112 or static code analyzer 113. Notably, method 400 is exemplary and other methods may also be used. Method 400 may be performed using hardware and/or software components described in FIGS. 1-2. Note that one or more of the operations may be deleted, combined, or performed in a different order as appropriate.

At operation 402, a code issue is detected. For example, compiler 212, static code analyzer 113, or code smell module 114, may receive source code in one or more source code files 202 and detect a code issue, such as code smell 204, code error, or the like.

At operation 404, the code issue and source code files 202 are received. For example, recursive circuit 108 may receive the code issue and source code files 202.

At operation 406, code issues are rectified using an AI system 110. For example, AI system 110 may include an LLM that may receive the code issue and source code files 202 and modify one of the source code files 202. Initially, the modified source code file may be the source code file 202M that includes the code issue. After the source code file 202M is modified, compiler 112, static code analyzer 113, interpreter 115 and/or code smell module 114, depending on the implementation, may determine whether the source code in the source code files 202 has additional code issues as a result of the modification. If so, the AI system 110 may continue to modify the same or different source code file (or multiple source code files), depending on the type of the source code issue, and recursively determine whether further modifications generate more code issues. The recursive process in operation 408 may continue until there are no further code issues, at which point operation 408 completes. In some instances, AI system 110 may modify the source code files 202 as described in method 300 for source code issues in addition to source code smells 204.

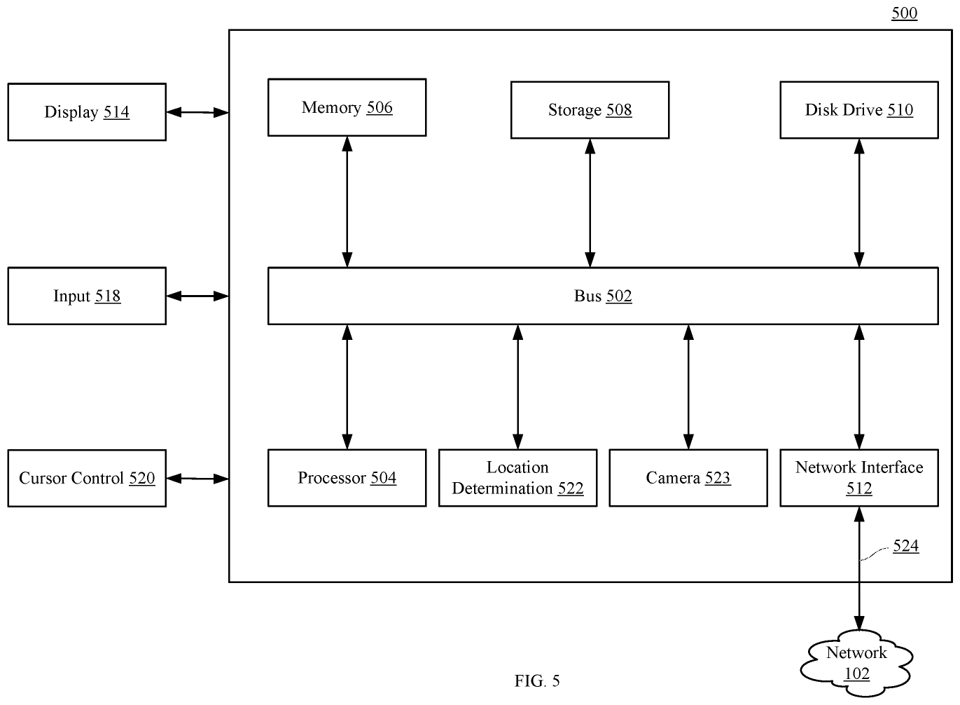

Referring now to FIG. 5 an embodiment of a computer system 500 suitable for implementing, the systems and methods described in FIGS. 1-4 is illustrated.

In accordance with various embodiments of the disclosure, computer system 500, such as a computer and/or a server, includes a bus 502 or other communication mechanism for communicating information, which interconnects subsystems and components, such as a processing component 504 (e.g., processor, micro-controller, digital signal processor (DSP), graphics processing unit (GPU), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), a location determination component 522 (e.g., a Global Positioning System (GPS) device as illustrated, a cell tower triangulation device, and/or a variety of other location determination devices known in the art), and/or a camera component 523. In one implementation, the disk drive component 510 may comprise a database having one or more disk drive components.

In accordance with embodiments of the disclosure, the computer system 500 performs specific operations by the processor 504 executing one or more sequences of instructions contained in the memory component 506, such as described herein with respect to the mobile communications devices, mobile devices, and/or servers. Such instructions may be read into the system memory component 506 from another computer readable medium, such as the static storage component 508 or the disk drive component 510. In other embodiments, hard-wired circuitry may be used in place of or in combination with software instructions to implement the disclosure.

Logic may be encoded in a computer readable medium, which may refer to any medium that participates in providing instructions to the processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 510, volatile media includes dynamic memory, such as the system memory component 506, and transmission media includes coaxial cables, copper wire, and fiber optics, including wires that comprise the bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 500. In various other embodiments of the disclosure, a plurality of the computer systems 500 coupled by a communication link 524 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 500 may transmit and receive messages, data, information and instructions, including one or more programs (i.e., application code) through the communication link 524 and the network interface component 512. The network interface component 512 may include an antenna, either separate or integrated, to enable transmission and reception via the communication link 524. Received program code may be executed by processor 504 as received and/or stored in disk drive component 510 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A method comprising:
determining a code smell in a plurality of source code files;
receiving the code smell and the plurality of source code files at a large language model; and
recursively modifying, using the large language model, at least one source code file in the plurality of source code files, until the code smell and an error associated with modifying the at least one source code file are removed from the plurality of source code files.

2. The method of claim 1, wherein the recursively modifying further comprises:
designating a first source code file in the plurality of source code files as a subject file, wherein the first source code file includes the code smell;
modifying, using the large language model, the subject file to correct the code smell;
compiling the plurality of source code files, including the modified subject file;
identifying, based on the compiling, the error in the plurality of source code files;
modifying, using the large language model, the subject file to correct the error; and
recompiling the plurality of source code files.

3. The method of claim 2, wherein the error is in the subject file and points to a location in the subject file, and further comprising:
generating, using the large language model, a prompt to modify the subject file; and
wherein the modifying the subject file to correct the error, further comprises modifying, using the large language model, the subject file based on the prompt.

4. The method of claim 2, wherein the error is in the subject file and points to a location in a second source code file in the plurality of source code files, and further comprising:
designating the second source code file as the subject file; and
wherein the modifying the subject file to correct the error, further comprises modifying the second source code file.

5. The method of claim 2, wherein the error is in a second source code file and the error points to the second source code file, and further comprising:
designating the second source code file as the subject file; and
wherein the modifying the subject file to correct the error, further comprises modifying the second source code file.

6. The method of claim 2, wherein the error is in a second source code file and the error points to the subject file, and further comprising:
generating, using the large language model, a strategy prompt having a plurality of options; and
selecting, using the large language model, one of the options in the plurality of options.

7. The method of claim 6, wherein the one of the options is to modify the subject file to correct the error.

8. The method of claim 6, wherein the one of the options is to modify the subject file and the second source code file to correct the error; and
further comprising designating the second source code file as the subject file.

9. The method of claim 6, wherein the one of the options is to modify the second source code file; and
further comprising designating the second source code file as the subject file.

10. A system comprising:
a non-transitory memory storing instructions; and
one or more hardware processors coupled to the non-transitory memory and configured to read the instructions from the non-transitory memory to cause the system to perform operations comprising:
determining a code issue in a plurality of source code files; and
rectifying the code issue, wherein the rectifying comprises recursively modifying, using a large language model, at least one source code file in the plurality of source code files, until the code issue and a second code issue associated with modifying the at least one source code file are rectified.

11. The system of claim 10, wherein to determine the code issue the operations further comprise:
receiving, at a code smell module, the plurality of source code files; and
determining, using the code smell module, the code issue that is a code smell.

12. The system of claim 10, wherein to determine the code issue the operations further comprise:
receiving, at a compiler, the plurality of source code files; and
determining, using the compiler, the code issue that is a compilation error.

13. The system of claim 10, wherein to determine the code issue the operations further comprise:
receiving, at a static code analyzer, the plurality of source code files; and
determining, using the static code analyzer, the code issue that is a code error.

14. The system of claim 10, wherein to rectify the code issue, the operations further comprise:
receiving, at the large language model, the plurality of source code files and the code issue;
modifying, using the large language model, a first source code file in the at least one source code file that includes the code issue;
compiling the plurality of source code files, wherein the compiling identifies the second code issue and a location that corresponds to the second code issue in the first source code file or a second source code file;
determining, using the modified source code file, the second code issue, and the location that corresponds to the second code issue, a strategy for rectifying the second code issue;
modifying the first source code file, the second source code file, or the first and second source code files based on the strategy; and
re-compiling the plurality of source code files.

15. The system of claim 14, wherein determining the strategy further comprises:
generating, using the large language model, a prompt corresponding to modifying the first source code file to remove the second code issue.

16. The system of claim 14, wherein determining the strategy further comprises:
generating, using the large language model, a prompt corresponding to modifying the second source code file to remove the second code issue.

17. The system of claim 14, wherein the re-compiling the plurality of source code files does not generate a compilation error; and
terminating the rectifying the code issue once the re-compiling does not generate the compilation error.

18. A non-transitory machine-readable medium having stored thereon machine-readable instructions executable to cause a machine to perform operations comprising:
determining a code smell in a source code file in a plurality of source code files; and
recursively:
modifying, using a large language model, at least one source code file in the plurality of source code files to correct the code smell; and
recompiling the plurality of source code files until the code smell and other errors that result from the modifying the at least one source code file are rectified.

19. The non-transitory machine-readable medium of claim 18, wherein the modifying inserts a solution to the code smell into the source code file or into a second source code file in the plurality of source code files to rectify the code smell in the source code file.

20. The non-transitory machine-readable medium of claim 19, further comprising:
recursively generating, using the large language model, a strategy for inserting the solution to the code smell into the source code file or into the second source code file.
